(19) United States
(12) Patent Application Publication
(10) Pub. No.: US 2009/0002899 A1
(43) Pub. Date: Jan. 1, 2009

(54) MAGNETORESISTIVE ELEMENT, MAGNETORESISTIVE HEAD, AND MAGNETIC DISK APPARATUS

(75) Inventor: Katsuhiko Koui, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/147,843

(22) Filed: Jun. 27, 2008

(30) Foreign Application Priority Data
Jun. 29, 2007 (JP) 2007-173471

(51) Int. Cl. G11B 5/33

(52) U.S. Cl. 360/324.12

(57) ABSTRACT

According to one embodiment, a magnetoresistive element includes a magnetization fixed layer, an intermediate layer provided on the magnetization fixed layer, a free layer provided on the intermediate layer, a separating layer composed of nonmagnetic metal and provided on the free layer, and a fluctuation compensated layer whose static magnetic coupling with the free layer is disconnected by the separating layer, whose magnetization direction is fixed so as to be antiparallel to the magnetization direction of the magnetization fixed layer, and provided on the separating layer.

### CROSS-REFERENCE TO RELATED APPLICATIONS

This application is based upon and claims the benefit of priority from Japanese Patent Application No. 2007-173471, filed Jun. 29, 2007, the entire contents of which are incorporated herein by reference.

### BACKGROUND

1. Field

One embodiment of the present invention relates to a magnetoresistive element for suppressing spin-transfer-induced noise, a magnetoresistive head, and a magnetic disk apparatus using the head.

2. Description of the Related Art

In recent years, magnetic recording and reproducing apparatuses, such as hard disk drives (HDDs), have rapidly been made higher in density. In parallel with this, magnetoresistive heads have been requested to achieve a higher recording density.

A vertical conducting magnetoresistive element has recently been investigated as a magnetoresistive effect element (spin valve film) whose magnetoresistive effect can be expected to improve (e.g., refer to Jpn. Pat. Appln. KOKAI Publication No. 2005-209301).

In the configuration written in the aforementioned patent document, the magnetization direction of the pinned layer and that of the free layer cross at right angles.

However, it has turned out that the following problem arises: when the magnetization direction of the pinned layer and that of the free layer are caused to cross at right angles as described above, for example, as the current density of the sense current is increased, noise is more liable to appear in the reproduced output. This is known as spin-transfer-induced noise (STIN). An effective method of suppressing STIN has been unknown.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary sectional view showing the configuration of a magnetoresistive head including a recording head and a reproducing head according to an embodiment of the invention;

FIG. 2 is an exemplary sectional view of the magnetoresistive head taken along line I-I of FIG. 1;

FIG. 3 is an exemplary sectional view showing the configuration parallel to the medium facing surface of a vertical conducting magnetic reproducing head according to the embodiment;

FIG. 4 is a drawing to help explain the principle of dynamic magnetic interaction;

FIG. 5 shows a typical profile of spin-transfer-induced noise (STIN);

FIG. 6 is an exemplary diagram showing the magnetization directions of a first pinned layer, a second pinned layer, a free layer, and a fluctuation compensated layer shown in FIG. 3;

FIG. 7 is an exemplary diagram showing the direction in which ST torque acts in a state where the magnetization directions of the first pinned layer, second pinned layer, free layer, and fluctuation compensated layer are as shown in FIG. 6;

FIG. 8 shows a noise profile when the fluctuation-compensated layer is eliminated from the configuration of FIG. 3;

FIG. 9 shows a noise profile of the configuration of FIG. 3;

FIG. 10A and FIG. 10B shows R-H curves in a state where the magnetization directions of the first pinned layer, second pinned layer, free layer, and fluctuation-compensated layer are as shown in FIG. 6;

FIG. 11A and FIG. 11B shows R-H curves of the configuration of FIG. 3;

FIG. 12 shows a modification of the configuration of FIG. 3;

FIG. 13 shows another modification of the configuration of FIG. 3;

FIG. 14 shows still a modification of the configuration of FIG. 3;

FIG. 15 is an exemplary perspective view of a magnetic recording and reproducing apparatus according to the embodiment; and

FIG. 16 is an exemplary perspective view of a magnetoresistive head assembly according to the embodiment.

### DETAILED DESCRIPTION

Various embodiments according to the invention will be described hereinafter with reference to the accompanying drawings. In general, according to one embodiment of the invention, a magnetoresistive element comprises a magnetization fixed layer, an intermediate layer formed on the magnetization fixed layer, a free layer formed on the intermediate layer, a separating layer composed of nonmagnetic metal and formed on the free layer, and a fluctuation compensated layer whose static magnetic coupling with the free layer is disconnected by the separating layer, whose magnetization direction is fixed so as to be antiparallel to the magnetization direction of the magnetization fixed layer, and formed on the separating layer.

Referring to the accompanying drawings, an embodiment of the invention will be explained.

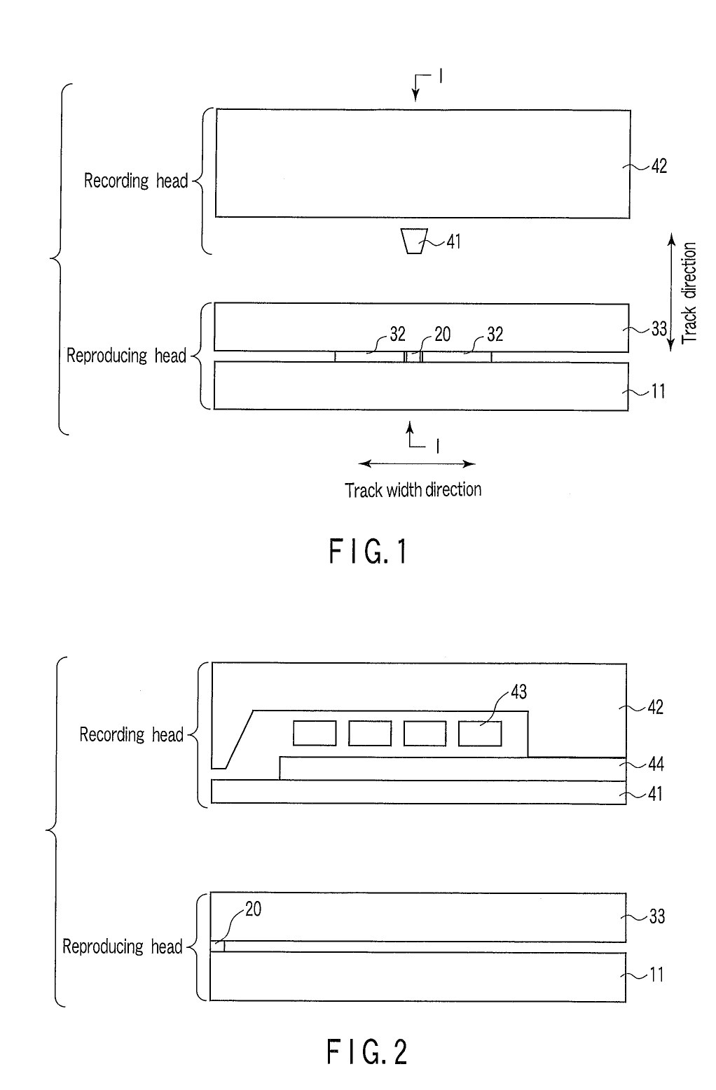

FIG. 1 is a sectional view showing the configuration of a magnetic head (magnetoresistive head) including a recording head and a reproducing head according to an embodiment of the invention. In FIG. 1, the cross section on the front side of the sheet is an airbearing surface (ABS) (medium-facing surface). FIG. 2 is a sectional view of the magnetic head taken along line I-I of FIG. 1.

As shown in FIGS. 1 and 2, the magnetic head includes a recording head 1 and a reproducing head 2. At the cross section of the recording head 1 viewed from the ABS surface, a main magnetic pole 41 and a return yoke 42 are exposed. Moreover, at the cross section of the reproducing head viewed from the ABS surface, an upper electrode and magnetic shield layer 33, a lower electrode and magnetic shield layer 11, a magnetoresistive element 20, and a bias magnetic field applying layer 32 are exposed. The magnetoresistive element 20 and bias magnetic field applying layer 32 are sandwiched between the upper electrode and magnetic shield layer 33 and lower electrode and magnetic shield layer 11.

At the time of sensing, the upper electrode and magnetic shield layer 33 and lower electrode and magnetic shield layer 11 cause current to flow through the magnetoresistive element 20 in the track direction.

As shown in the sectional view of FIG. 2, the recording head 1 is composed of a main magnetic pole 41 composed of magnetic material, an exciting coil 43 composed of conductive material, such as Cu, and a return yoke 42 which is composed of magnetic material and which is connected to the main magnetic pole 41 via an auxiliary magnetic pole 44.

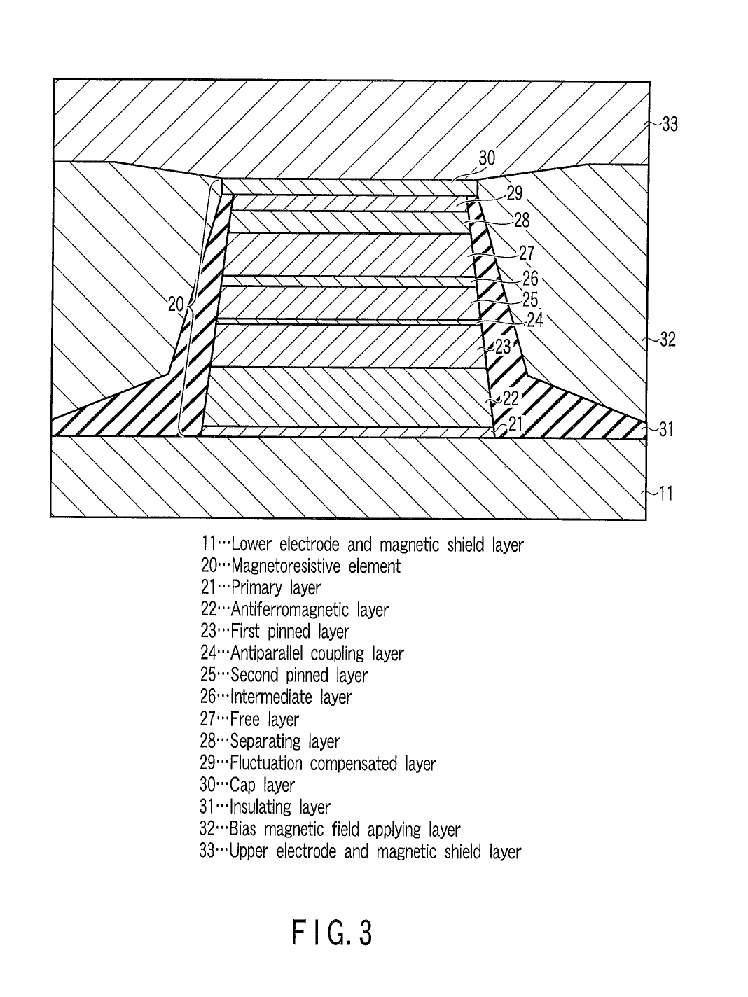

Next, the configuration of the reproducing head 2 will be explained. FIG. 3 is a sectional view showing the configuration parallel to the medium facing surface of a vertical conducting magnetic reproducing head according to the embodiment. The magnetoresistive element 20 is provided on the lower electrode and magnetic shield layer 11 composed of, for example, NiFe, on an Al₂O₃—TiC (altic) substrate (not shown). On the magnetoresistive element 20, the upper electrode and magnetic shield layer 33 is provided. On both sides of the magnetoresistive element 20, the bias magnetic field applying layers 32 composed of Cr/CoCrPt are formed via an insulating film 4 composed of aluminum. Using the lower electrode and magnetic shield layer 11 and upper electrode and magnetic shield layer 33, sense current is caused to flow through the magnetoresistive element 20 in the direction perpendicular to the film surface. Moreover, the bias applying films 31 apply a bias magnetic field to the magnetoresistive element 20.

The magnetoresistive element 20 has a structure where an primary layer 21, an antiferromagnetic layer 22, a first pinned layer 23, an antiparallel coupling layer 24, a second pinned layer (magnetization fixed layer) 15, an intermediate layer 26, a free layer 27 composed of CoFe and NiFe, a separating layer 28, a fluctuation compensated layer 29, and a cap layer 30 are stacked one on top of another in that order.

Ta and Ru are used as the primary layer 21. Ta/NiFeCr or Ta/Cu may be used as the primary layer 21.

An Mn antiferromagnetic alloy, such as IrMn, PtMn, NiMn, or FeMn, is used as the antiferromagnetic layer 22. The film thickness of the antiferromagnetic layer 22 is, for example, 3 to 20 nm.

Each of the first pinned layer 23 and second pinned layer 25 has a synthetic antiferromagnetic structure (abbreviated as a synthetic structure) where magnetizations are coupled in an antiparallel manner via the antiparallel coupling layer 24. The first and second pinned layers 23, 25 are composed of a ferromagnetic alloy basically composed of, for example, Co, Fe, or Ni. In the embodiment, the first and second pinned layers 23, 25 are composed of 2.5CoFe. The film thickness of each of the first and second pinned layers 23, 23 is, for example, 1 to 20 nm.

The antiparallel coupling layer 24 is composed of nonmagnetic metal, such as Ru, Rh, or Cr. It is desirable that the film thickness of the antiparallel coupling layer 24 should be 0.2 to 2 nm.

The intermediate layer 26 is composed of insulating material, such as Al₂O₃ or MgO, or nonmagnetic metal, such as Cu, Au, Ag, Al, Os, or Ir, and alloy, or a composite structure of the above oxide and metal. The film thickness of the intermediate layer 26 is, for example, 0.2 to 20 nm.

The free layer 27 senses a magnetic field from media. The bias magnetic field applying layer 32 is provided to stabilize the magnetization of the free layer 27. The bias magnetic field applying layer 32 is composed of hard magnetic material, such as an alloy of Co, Fe, or Cr.

The electrode and magnetic shield layers 11, 33 are composed of soft magnetic metal material consisting mainly of, for example, Ni.

The separating layer 28 is composed of material which has not only the property of disconnecting the static magnetic coupling of the fluctuation compensated layer 29 with the free layer 27 but also the capability of transmitting spin-transfer (ST) torque. Specifically, it is desirable that the separating layer 28 should be composed of a nonmagnetic metal layer consisting mainly of nonmagnetic metal, such as Cr, Ru, Rh, or Pt. Moreover, to disconnect the static magnetic coupling, the film thickness of the separating layer 28 is preferably 1 nm or more. If the film thick of the separating layer 28 is 5 nm or more, the static magnetic coupling can be disconnected stably. On the other hand, if the film thickness of the separating layer 28 is 20 nm or more, since the distance between shields has to be made larger in putting all of the magnetoresistive element 20 between the upper and lower electrode and shield layers 11, 33, it is difficult to increase the reproduction resolution. Therefore, it is desirable that the film thickness of the separating layer 28 should be 20 nm or less. Moreover, to transmit ST torque with no attenuation, the separating layer 28 is preferably 10 nm or less.

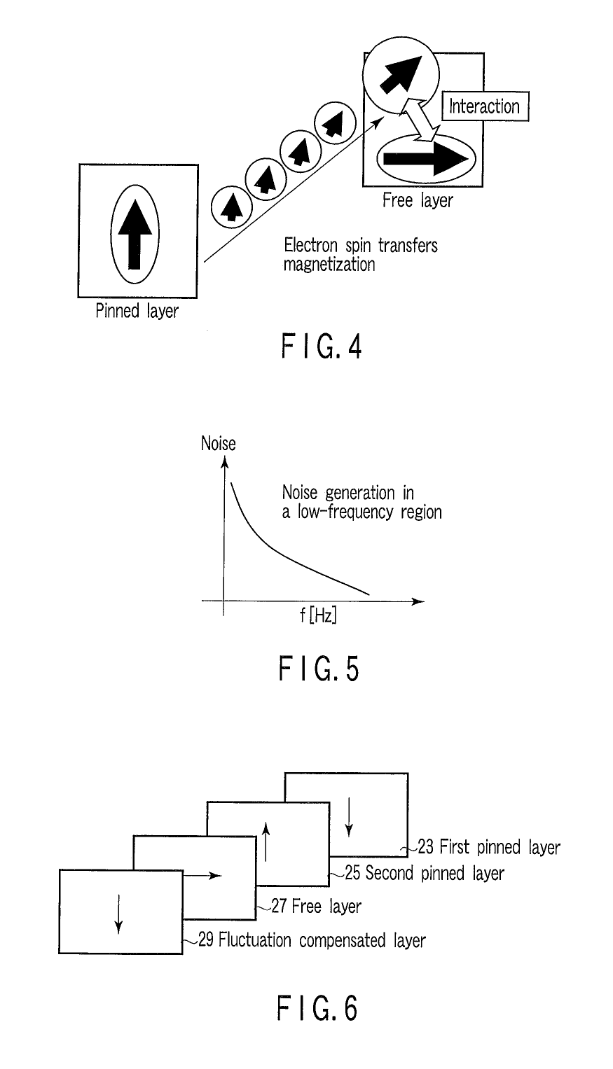

Here, “static magnetic coupling” means magnetostatic coupling and PKKY interaction and is magnetic coupling that functions constantly, regardless of whether or not the element is operating. On the other hand, ST torque is dynamic magnetic interaction that acts only when sense current is caused to flow. The principle of the interaction is expressed as shown in FIG. 4 as follows: when conduction electrons go into the free layer 27 from the second pinned layer 25, since there is a component that goes on, while maintaining the spin polarization by the magnetization of the pinned layer 25, the electrons exchange-interact in the free layer 27, producing torque that inclines the magnetization direction of the free layer 27 in the same direction as that of the second spin layer 25. The interaction occurs, regardless of the conducting direction. Since more electrons flow from the second pinned layer 25 into the free layer 27 when current is caused flow from the free layer 27 to a layer whose magnetization is fixed, the interaction acts more intensely than when the current is caused to flow in the opposite direction. FIG. 5 shows a typical profile of spin-transfer-induced noise (STIN). Generating abrupt low-frequency noise has an effect on the SN ratio, which exerts an adverse effect on the magnetic recording and reproducing quality.

The fluctuation compensated layer 29 is composed of ferromagnetic material. In the fluctuation compensated layer 29, magnetization is practically fixed. Hard magnetic material obtained by adding Cr, Pt, or the like to an alloy consisting primarily of Co, Fe, or Ni may be used as a material for layer 29. The magnetization direction of each of the magnetic layers is shown in FIG. 6.

As shown in FIG. 6, the magnetization direction of the first pinned layer 23 is antiparallel to that of the second pinned layer 25. The magnetization direction of the free layer 27 is in a direction perpendicular to the second pinned layer 25. The magnetization direction of the fluctuation compensated layer 29 is antiparallel to that of the second pinned layer 25 and is in a direction perpendicular to the magnetization direction of the free layer 27.

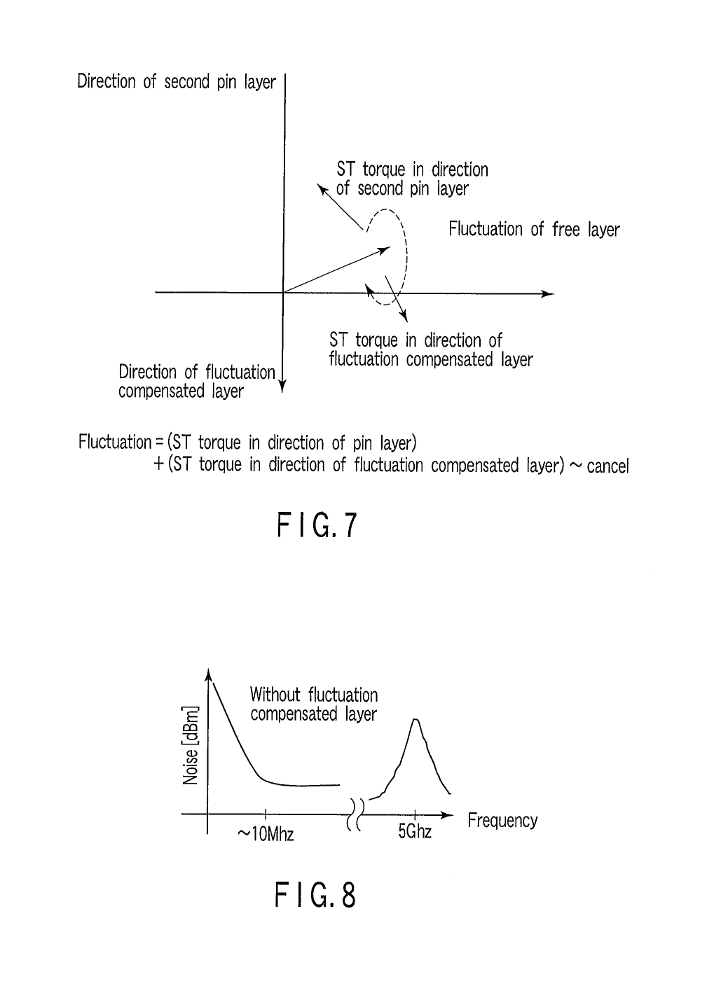

FIG. 7 shows the direction in which ST torque acts when an adjustment is made in such a magnetization direction. The free layer 27 looks in the magnetization direction according to the medium magnetic field, producing a magnetoresistive effect between the free layer and the pinned layer 25. At the same time, the free layer 27 generates STIN since ST torque is produced between the free layer and the pinned layer 25. On the other hand, ST torque is also produced between the fluctuation compensated layer 29 and free layer 27, which generates STIN. Since the noise phase is opposite to the one between pinned layers, they cancel each other, functioning so as to reduce noise. As a result, the SN ratio can be improved as compared with a case where there is no fluctuation compensated layer 29.

Furthermore, since the ST torque not only generates noise but also changes the magnetization direction macroscopically, there is a possibility that the ST torque will act on the direction of the free layer 27 and have an effect on the bias point of the output. However, the formation of the fluctuation compensated layer enables the torque to be cancelled, which makes it possible to avoid the risk of a shift in the bias point.

The principal embodiment of the invention and the principle of its operation have been explained above. Hereinafter, a preferred embodiment of the invention in terms of characteristics will be explained.

The fluctuation compensated layer 29 contributes noise reduction. Between the fluctuation compensated layer 29 and free layer 27, a magnetoresistive effect develops. The contribution of the part to the output is in opposite phase with the magnetoresistive effect between the free layer 27 and second pinned layer 25, which contributes to a decrease in the output. To reduce the adverse effect to a negligible extent, the magnetoresistive effect between the free layer 27 and fluctuation compensated layer 29 has to be decreased to the extent that it can be neglected as compared with the magnetoresistive effect between the free layer 27 and pinned layer 25. Specifically, a combination of an alloy consisting mainly of Co, Fe, or Ni and nonmagnetic metal, such as, Cr, Ru, Rh, or Pt described above for the fluctuation compensated layer 29 and separating layer 28 exhibits very small variation in resistance. For example, when a magnetoresistive element is composed using these metals, a percentage resistance change of 1% or less at the most is obtained. Therefore, the combination is suitable for the object of the invention. For example, when the intermediate layer of FIG. 3 is a TMR element using Al₂O₃ or MgO, the magnetoresistive effect reaches 20% or more, which makes it possible to virtually neglect the adverse effect of the fluctuation compensated layer 29.

In the above configuration, since the ST interaction from the pinned layer 25 to the free layer 27 is very great, the conducting direction is so set that current flows from the pinned layer 25 to the free layer (electrons flow from the free layer 27 to the second pinned layer 25) and the contribution of the fluctuation compensated layer 29 is increased, which makes it possible not only to reduce noise more but also to effectively correct a shift in the bias point.

FIGS. 8 and 9 show a comparison of a noise profile between a case where the above configuration is used and a case where the fluctuation compensated layer 29 is eliminated.

FIG. 8 shows a noise profile when the fluctuation compensated layer 29 is eliminated. In the noise profile of FIG. 8, low-frequency noise appears distinctly. The peak measured at the same time and found in the GHz band shows that the cause of an increase in the noise including low frequencies lies in STIN. FIG. 9 shows a case where the above-described configuration is used. In FIG. 9, low-frequency noise decreases and, at the same time, noise in the GHz band also decreases. This results from STIN being suppressed by the fluctuation compensated layer 29.

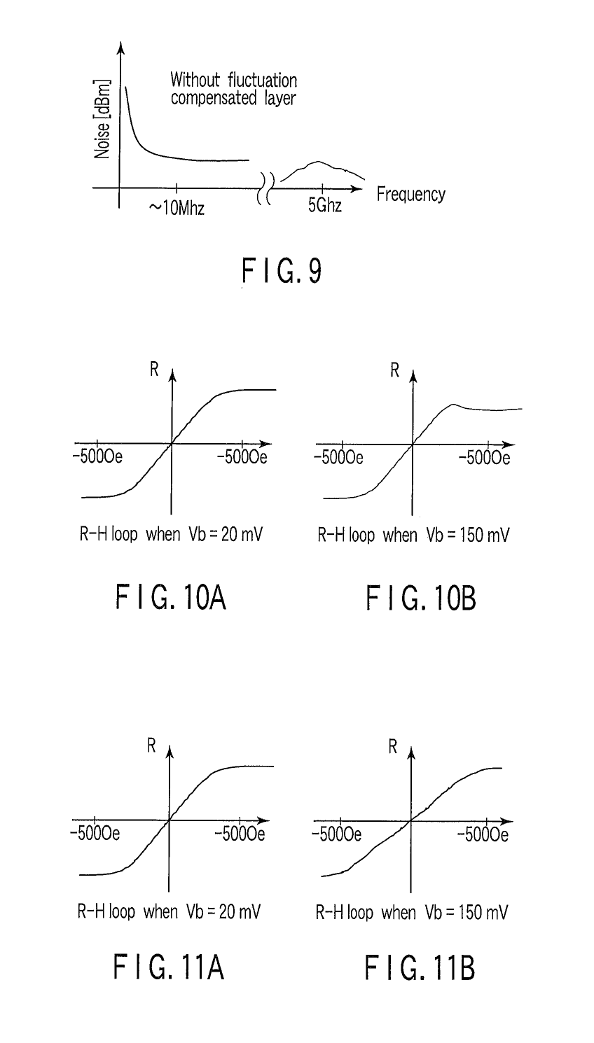

FIGS. 10A, 10B, 11A, and 11B show a comparison of a shift in the bias point between a case where the above configuration is used and a case where the fluctuation compensated layer 29 is eliminated. FIGS. 10A and 10B shows RH curves when the fluctuation compensated layer 29 is eliminated. The ST torque makes it more difficult to make the free layer 27 and pinned layer antiparallel with each other, which decreases the maximum resistance value. In contrast, in a case where the fluctuation compensated layer 29 is provided as shown in FIGS. 11 and 11B, a loop form remaining almost unchanged is obtained, which produces very good signal symmetry.

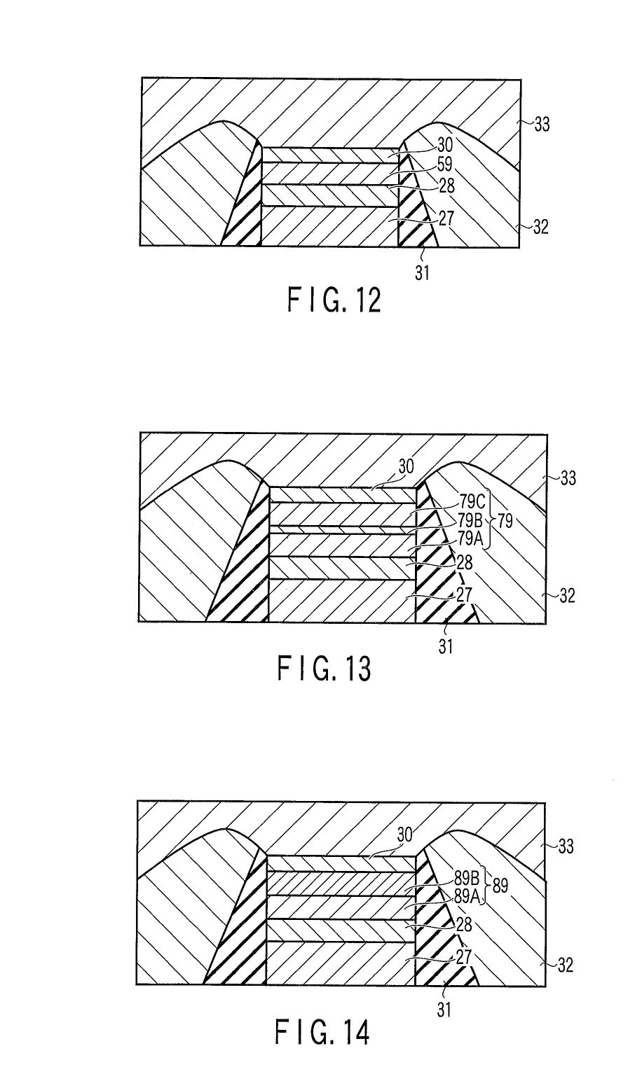

FIGS. 12, 13, and 14 are modifications of the structure shown in FIG. 1.

The structure of FIG. 12 is such that a fluctuation compensated layer 59 is composed of hard magnetic material and a separating layer 28 and a bias magnetic field applying layer 32 are not connected to each other. In FIGS. 12 to 14, since the structure of the lower layer of the free layer 27 is the same as that of FIG. 3, its diagrammatic representation is omitted.

The structure of FIG. 13 is characterized in that the fluctuation compensated layer 79 has a synthetic antiferromagnetic structure where a ferromagnetic layer 79A, an antiparallel coupling layer 79B, and a hard magnetic layer 79C are stacked one on top of another. At least one of the layers 79A and 79B is composed of hard magnetic material, thereby enabling the layer to be fixed in a direction perpendicular to the pinned layer. This makes it possible to eliminate the effect of destabilization due to heat fluctuation, even if the size is made smaller so as to cope with a narrower track. Moreover, although being at a disadvantage in making the gap narrower, the bias applying film edge forming process can be implemented easily, because the process has not been changed from the conventional equivalent.

In FIG. 14, the structure of a fluctuation compensated layer 89 is such that the magnetization direction of a ferromagnetic layer (fluctuation compensated layer) 89A is fixed by an antiferromagnetic layer 89B. In this case, too, as with the embodiment of FIG. 7, the structure is characterized in that the effect of destabilization due to heat fluctuation can be eliminated, even if the size is made smaller, and that the bias applying film edge forming process can be implemented easily, because the process has not been changed from the conventional equivalent.

Furthermore, the configuration of FIG. 13 may be combined with that of FIG. 14, thereby stacking an antiferromagnetic film on a synthetic antiferromagnetic structure to fix the magnetization direction.

Next, a magnetic recording and reproducing apparatus in which a magnetoresistive element of the embodiment has been installed will be explained. A magnetoresistive element or magnetic head of the embodiment can be incorporated into, for example, an integral recording and reproducing magnetic head assembly and installed in the magnetic recording and reproducing apparatus.

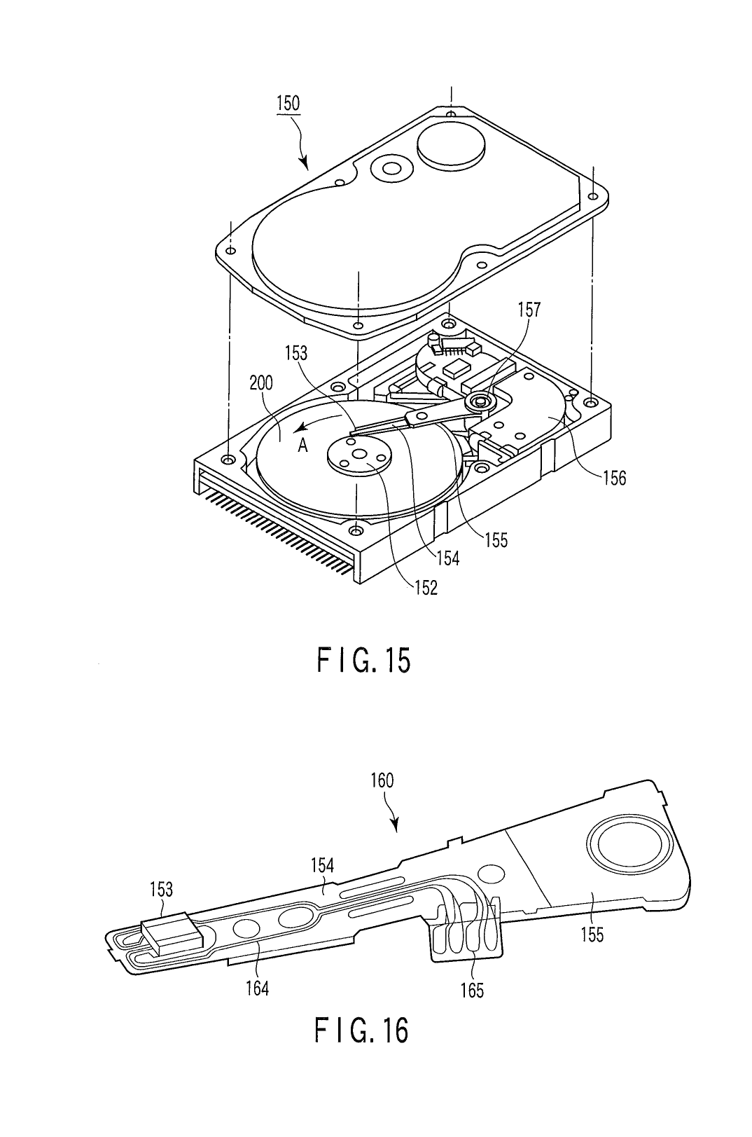

FIG. 15 is a perspective view schematically showing the chief part of the magnetic recording and reproducing apparatus. The magnetic recording and reproducing apparatus 150 is of the type using a rotary actuator. In FIG. 15, a magnetic disk 200, which is mounted on a spindle 152, is rotated in the direction shown by arrow A by a motor (not shown) in response to a control signal from a drive unit control section (not shown). The magnetic recording and reproducing apparatus 150 of the invention may include a plurality of magnetic disks 200.

A head slider 153 for recording and reproducing information to be stored into and reproduced from the magnetic disk 200 is provided at the tip of a suspension 154. The head slider 153 has a magnetic head including the aforementioned reproducing head and recording head mounted near its tip.

When the magnetic disk 200 rotates, the medium facing surface (ABS) of the head slider 153 is held a specified amount of floating above the surface of the magnetic disk 200. Alternatively, the slider may be of the contact running type that allows the slider to be in contact with the magnetic disk 200.

The suspension 154 is connected to one end of an actuator arm 155 which has a bobbin section that holds a drive coil (not shown). To the other end of the actuator arm 155, a voice coil motor 156, a kind of linear motor, is provided. The voice coil motor 156 is composed of a drive coil (not shown) wound around the bobbin section of the actuator arm 155 and a magnetic circuit composed of a permanent magnet and a facing yoke arranged so as to face each other in such a manner that the coil is sandwiched between them.

The actuator arm 155 is held by ball bearings (not shown) provided at the top and bottom (or two places) of the spindle 157 and is slide-rotated freely by the voice coil motor 156.

FIG. 16 is an enlarged perspective view of the magnetic head assembly at the leading part of the actuator arm 155 when viewed from the disk side. That is, the magnetic head assembly 160 includes the actuator arm 155 that has the bobbin section holding, for example, a drive coil. To one end of the actuator arm 155, the suspension 154 is connected.

At the tip of the suspension 154, the head slider 153 with the magnetic head is provided. The suspension 154 has a signal wiring and reading lead line 164. The lead line 164 is electrically connected to the individual electrodes of the magnetic head incorporated into the head slider 153. In FIG. 16, numeral 165 indicates an electrode pad for the magnetic head assembly 160.

The use of the above-described reproducing magnetic head makes it possible to reliably read information magnetically recorded on a magnetic disk 200 at a higher recording density than in the conventional art.

As described above in detail, the use of the magnetoresistive effect head makes it possible not only to make the gap and track narrower and therefore increase the recording density but also to apply a good bias magnetic field, which further makes it possible to realize a good linear operation and lower noise and therefore provide a reproduced signal with a high signal-to-noise ratio.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetoresistive element comprising:
a magnetization fixed layer;
an intermediate layer provided on the magnetization fixed layer;
a free layer provided on the intermediate layer;
a separating layer composed of nonmagnetic metal and provided on the free layer; and
a fluctuation compensated layer whose static magnetic coupling with the free layer is disconnected by the separating layer, whose magnetization direction is fixed so as to be antiparallel to the magnetization direction of the magnetization fixed layer, and provided on the separating layer.

2. A magnetoresistive head comprising:
a magnetoresistive element including a magnetization fixed layer, an intermediate layer provided on the magnetization fixed layer, a free layer whose magnetization is fixed in a direction perpendicular to the magnetization direction of the magnetization fixed layer and provided on the intermediate layer, a separating layer composed of nonmagnetic metal and provided on the free layer, a fluctuation compensated layer whose static magnetic coupling with the free layer is disconnected by the separating layer and whose magnetization direction is fixed so as to be antiparallel to the magnetization direction of the magnetization fixed layer and cross the magnetization direction of the free layer at almost right angles and provided on the separating layer, and a cap layer composed of nonmagnetic metal and provided on the fluctuation compensated layer;
a pair of electrode and magnetic shields provided on the top face and bottom face of the magnetoresistive element; and
a pair of bias magnetic field applying layers provided so as to sandwich the magnetoresistive element therebetween and whose magnetization direction is fixed to stabilize the magnetization direction of the free layer.

3. The magnetoresistive head according to claim 2, wherein the film thickness of the separating layer is 1 nm or more and 20 nm or less.

4. The magnetoresistive head according to claim 2, wherein the fluctuation compensated layer is connected to the pair of bias applying films and does not magnetostatically couple with the electrode and magnetic shield provided on the top face of the magnetoresistive element.

5. The magnetoresistive head according to claim 2, wherein the fluctuation compensated layer is composed of a stacked-layer structure of an antiferromagnetic layer and a ferromagnetic layer.

6. The magnetoresistive head according to claim 2, wherein the fluctuation compensated layer has a synthetic antiferromagnetic structure.

7. The magnetoresistive head according to claim 2, wherein current is caused to flow from the electrode and magnetic shield on the magnetization fixed layer side to the electrode and magnetic shield on the fluctuation compensated layer side.

8. A magnetic disk apparatus comprising:
a magnetoresistive head which includes
a magnetoresistive element including a magnetization fixed layer, an intermediate layer provided on the magnetization fixed layer, a free layer whose magnetization is fixed in a direction perpendicular to the magnetization direction of the magnetization fixed layer and provided on the intermediate layer, a separating layer composed of nonmagnetic metal and provided on the free layer, a fluctuation compensated layer whose static magnetic coupling with the free layer is disconnected by the separating layer and whose magnetization direction is fixed so as to be antiparallel to the magnetization direction of the magnetization fixed layer and cross the magnetization direction of the free layer at almost right angles and provided on the separating layer, and a cap layer composed of nonmagnetic metal provided on the fluctuation compensated layer,
a pair of electrode and magnetic shields provided on the top face and bottom face of the magnetoresistive element, and
a pair of bias applying films provided so as to sandwich the magnetoresistive element therebetween and whose magnetization direction is fixed to stabilize the magnetization direction of the free layer.

9. The magnetic disk apparatus according to claim 8, wherein the film thickness of the separating layer is 1 nm or more and 20 nm or less.

10. The magnetic disk apparatus according to claim 8, wherein the fluctuation compensated layer is composed of a ferromagnetic layer.

11. The magnetic disk apparatus according to claim 8, wherein the fluctuation compensated layer is connected to the pair of bias applying films and does not couple magnetostatically with the electrode and magnetic shield provided on the top face of the magnetoresistive element.

12. The magnetic disk apparatus according to claim 8, wherein the fluctuation compensated layer is composed of a stacked-layer structure of an antiferromagnetic layer and a ferromagnetic layer.

13. The magnetic disk apparatus according to claim 8, wherein current is caused to flow from the electrode and magnetic shield on the magnetization fixed layer side to the electrode and magnetic shield on the fluctuation compensated layer side.
